(19) United States
(12) Patent Application Publication
(10) Pub. No.: US 2026/0264285 A1
(43) Pub. Date: Sep. 10, 2026

(54) FIREWOOD SPLITTING MACHINE

(71) Applicants: Srecko PERTINAC, Sentjur (SI); David KOPRIVC, Sveti Stefan (SI)

(72) Inventors: Srecko PERTINAC, Sentjur (SI); David KOPRIVC, Sveti Stefan (SI)

(21) Appl. No.: 18/868,941

(22) PCT Filed: Mar. 7, 2023
(86) PCT No.: PCT/SI2023/000002

§ 371 Date: Nov. 25, 2024

(30) Foreign Application Priority Data
May 31, 2022 (SI) P-202200085

(51) Int. Cl. B27L 7/06

(52) U.S. Cl. CPC B27L 7/06

(57) ABSTRACT

A firewood splitting machine for splitting longitudinal timber sections to produce firewood pieces. A splitting tool is located in a third level spaced apart from a bottom surface of an operational area of the machine in a first level. The splitting chute is located in a fourth level disposed a distance above the ground that is smaller than a distance between a cutting blade of the splitting tool and the ground. The splitting chute and the splitting tool are simultaneously displaceable in the same direction along a horizontal axis and in vertical direction relative to the splitting tool and the bearing frame, either towards the ground or in the opposite direction, so that during displacing of the splitting tool and splitting chute, the distance between the splitting chute and the primary cutting blade of the splitting tool is all the time changeable within a pre-determined range.

### CROSS-REFERENCE TO RELATED APPLICATIONS

This application is a United States national phase application of co-pending International Patent Application No. PCT/SI2023/000002, filed on 7 Mar. 2023, which claims the benefit of Slovenia Patent Application No. P-202200085 filed 31 May 2022, both of which are hereby incorporated by reference in their entirety.

### BACKGROUND

The present disclosure belongs to performing operations, namely processing of wood, and in particular to firewood splitting machines, operating by means cutting blades or wedges. Pursuant to the International Patent Classification, such inventions belong to the class B 27 L 07/06.

In this, the present disclosure relates to a machine, by which a timber section, which has been previously cut to a pre-determined length, by taking into consideration the structure and natural properties of the wood, with essentially reduced energy consumption and with minimal losses of wood mass and efficiently split to particular firewood pieces, which is suitable for direct application in household furnaces.

It was well known that wood is an orthotropic material, since physical properties thereof in various directions may essentially differ from each other. Similarly, like an onion in the radial direction of a timber there are various layers, so called annual rings, and is, either still natural or dried, in longitudinal direction usually much easier split in radial planes than in other directions. In addition to that, a timber usually includes randomly distributed wood knots, to which the structure of the wood is adapted, such that adjacent to each of them the annual rings and also longitudinal weak areas are slightly deflected. Taking these natural properties into account when splitting the wood may require less energy consumption, whereas neglecting to take into account these natural properties of the wood structure may require a larger amount of force and consequently a larger amount of energy consumption.

Machines for a so-called single-phase splitting of timber sections of a pre-determined length are known in the prior art, which are generally equipped with a splitting unit, comprising either a single cutting blade or several cutting blades. In such a case, a timber section of a pre-determined length of a single-phase, which is a single stroke of said splitting unit relatively to said timber section, or, depending on the shape of said splitting unit, a split of two or more firewood pieces. A machine furnished with a splitting unit having just a single cutting blade is disclosed in CA 1,084,814. However, the machine described therein requires numerous strokes, which are required to split each particular timber section of a pre-determined length to firewood pieces of suitable dimensions for direct application in household furnaces, thereby increasing energy consumption. Energy consumption may increase when the cutting blade starts cutting the wood structure in a direction that is inclined with respect to the annual rings, or in a direction, which is deflected with respect to radial plane in the longitudinal direction of the timber section. In this case, energy consumption may depend on the sharpness or high speed of the cutting blade. This happens in practice, when the cutting blade abuts a wood knot, upon which a direction of progression of the cutting blade may change with respect to the initially intended direction. In such case the force required for progression of the splitting unit, and also the corresponding energy consumption, may essentially increase. Moreover, a quantity of commercially inappropriate wood waste, which is produced by splitting of wood in addition to regular firewood pieces, may also increase.

In order to improve efficiency, further machines with splitting units with several cutting blades have also been developed, and one of such machines is e.g. disclosed in PCT/CH2005/000175. Productivity may be improved with such a machine compared to the previously described examples, but the forces required for splitting may be still higher, so that such a machine is pretty bulky, energy consuming and moreover difficultly transportable to each desired operational area.

A multi-phase machine for timber processing due to production of firewood pieces is disclosed in WO 99/6214. Such machine comprises a bearing frame, which is furnished with supporting legs and is therefore maintained at certain distance above the ground. Longitudinal sidewalls of said bearing frame are furnished with guiding members for guiding of a guiding frame, which is adapted to receive each timber section that is intended to be split. The guiding frame is by means of said guiding members displaceable in the longitudinal direction of the bearing frame. A bearing plate is arranged between said sidewalls of the bearing frame defining the longitudinal direction of the machine, and is adapted for supporting of a timber section, which was previously separated from the timber but has not yet been split, until said timber section is located within the area of the guiding frame. The length of said bearing plate should be shorter than the length of the guiding frame or the length of the timber section intended to be split. Said bearing frame is in its one terminal area furnished with a driving means, which is suitable for displacing each timber section intended to be split relatively to each disposable splitting unit and the guiding frame along the bearing frame. Said driving means is a longitudinally directed hydraulic cylinder, which is attached to the bearing frame, while its piston rod is connected with the guiding frame. In the opposite terminal area of said bearing frame there is a splitting unit, which is furnished with a plurality of cutting blades, namely a primary cutting blade in form of a plate arranged in s horizontal plane, and several secondary cutting blades, which are arranged below said primary cutting blade and extend in longitudinal direction transversally with respect to said primary cutting blade and are suitably spaced apart from each other and moreover also offset with respect to said primary cutting blade in a direction away from the bearing frame.

A timber section is placed into said guiding frame, upon which said driving means pushes said guiding frame in a direction towards the splitting unit, in which the timber section is split to several firewood pieces, which freely fall into a collector or onto ground below the bearing frame. Such multi-phase firewood splitting machine is also disclosed in SI 25007 A and SI 25612 A. Such machines may be efficiently used in processing of wood with suitable structure resulting from particular kinds of trees, where properties of the wood are not extremely orthotropic, so that the wood is regularly split.

A further firewood splitting machine, as disclosed in EP 0 928 940 A1, comprises a splitting unit with multiple cutting blades, which is in a horizontal plane back and forth displaceable along a bearing frame, as well as a bearing chute, which is integrated with said splitting unit to form a unit therewith. The splitting unit and bearing chute are together displaceable in the same direction. Consequently, said splitting unit includes a primary cutting blade, which extends along the bearing chute, and secondary cutting blades arranged over said primary cutting blade. The secondary cutting blades are permanently maintained at a pre-determined distance apart from each other, namely at a distance between the primary cutting blade and a bearing chute.

The part of the wood that has been cut-off by means of the primary cutting tool is during progression of the splitting unit gradually introduced between the primary cutting edge and the bearing chute, by which said part is further split to several separate firewood pieces. As explained above, the wood is orthotropic and has various properties in different directions, so that also its splitting abilities in various directions may be quite different. For that reason, in the area between the primary cutting blade and said bearing chute starts splitting in directions and planes that were initially determined by the cutting blade. The subsequent directions of splitting merely depend on the natural structure and configuration of the wood, wherein such splitting should, where possible, be continued in directions that require less energy consumption. However, the distance between the primary cutting blade and the bearing chute is unchangeable, and in practice it is common for the wood, because of its changing shape and cross-section during progression of the splitting unit, to get jammed between the primary cutting blade and the bearing chute. This can be overcome only by essentially increasing the force on the driving means, which may together with possible deformation of the wood enable further progression of the splitting unit in order to prevent the machine from the total jam and interruption of operation thereof. In certain cases, a pre-determined distance between the primary cutting blade and the bearing chute is insufficient to compensate for the required deformation of the wood, which could overcome said jamming while the available pushing force in the driving unit still ensures progression of the splitting unit. In such case, said primary cutting blade and/or secondary cutting blades start cutting the wood in a direction, which is inclined with respect to the regular plane or direction of splitting. In such situation however the forces, which may be required for further progression of cutting blades, may suddenly increase for several times, by which also energy consumption is correspondingly increased. Such situations can be managed only of the machine as such is bulky enough, and if the hydraulic system is capable of generating such forces. If yes, then the common weight of such machine should be essential, which may make the machine more expensive and may simultaneously hinder its mobility. Moreover, the hydraulic system of such complex machine may be energy consuming and generate essential losses during its operation. This may also lead to the risk of environment pollution, because potential emissions of the hydraulic media also need to be taken into consideration.

Firewood splitting machines are also disclosed in EP 3 205 466 A1, U.S. Pat. No. 4,799,519 A and S 25 007 A.

The proposed disclosure refers to a firewood splitting machine, wherein such machine may generally include one or more of:
a self-standing bearing frame adapted to be rest on the ground and supported by supporting legs and maintained at a sufficient distance above the ground. The self-standing bearing frame is also detachably connectable with a three-point coupling mechanism of a tractor, where a hydraulic driving assembly is mounted to said bearing frame. The hydraulic driving assembly includes a hydraulic pump, which is via a Cardan shaft connectable with a driving shaft on said tractor, as well as a hydraulic liquid reservoir and suitable hydraulic driving means, which are via suitable hydraulic pipes and hydraulic control valves connected with said hydraulic pump and said reservoir;
a hydraulically driven conveying unit, which is arranged in the one terminal area of said bearing frame of the machine and is suitable for displacing of a timber that is thinner than a pre-determined maximum diameter along the longitudinal geometric axis of said frame by forwarding each previously cut-off longitudinal timber section along said longitudinal geometric axis towards the working area. The working area is located at the first level at a sufficient distance above the ground and simultaneously lower than the second level, in which said conveying unit for supplying of timbers is located;
a cutting unit that is suitable for successively cutting a timber to separate longitudinal timber sections of pre-determined length and is located above said conveying unit. The cutting unit is adjusted for cutting of timbers along the vertical plane, which extends rectangular both with respect to the ground and also to said longitudinal geometric axis of the bearing frame, along which the timber section is forwarded through the machine;
a terminal limiting member that is arranged opposite the terminal area of the bearing frame, namely oppositely with respect to said conveying unit, and is adjusted for supporting said timber section of a pre-determined length in a direction along said longitudinal geometric axis of the bearing frame, i.e., in a direction of forwarding of said timber section along the machine;
a splitting unit that is guided in said longitudinal direction of the bearing frame suitable guiding members and is driven by at least one hydraulic means integrated into said hydraulic driving assembly. The splitting unit is also adapted for splitting of said timber section to firewood pieces where said splitting unit comprises at least a splitting tool that is displaceable by the driving means back and forth along said longitudinal geometric axis of the bearing frame. The splitting unit is furnished with a primary cutting blade, which is located at the third level that is, depending on each selected thickness of firewood pieces, located at a pre-determined distance in direction away from the ground apart from the first level of the bottom surface of the working area; and/or
a splitting chute that is adjusted for supporting said longitudinal timber section together with gradually split-off firewood pieces at least in the area of operation of said splitting tool, and is simultaneously with said splitting tool displaceable back and forth along said longitudinal direction of the bearing frame and in the same direction as said splitting tool.

The present disclosure proposes that said splitting chute is located in the fourth level, the distance of which from the ground is substantially, for a thickness of firewood pieces, smaller than the distance of the primary cutting blade of the splitting tool of the splitting unit in the third level from the ground. The splitting chute, when observed in a direction of the operational stroke of the splitting tool and the chute during the splitting, namely by moving from the conveying unit towards the terminal limiting member, is located in front of the splitting tool. The splitting chute is simultaneously, with the splitting tool and also in the same direction as the splitting tool, displaceable in a horizontal direction and is displaceable also in a vertical direction, namely in a direction towards the ground as well as in opposite direction, so that, during displacement of the splitting tool and the splitting chute, the distance between the splitting chute and the primary cutting blade of the splitting tool is all the time changeable within a pre-determined range.

The minimum distance between the third level of the primary cutting blade of the splitting tool and the fourth level of the splitting chute is changeable and is prior to splitting adjustable in advance depending on each selected thickness of firewood pieces. The minimum distance between the third level of the primary cutting blade of the splitting tool and the fourth level of the splitting chute is, during each movement of the splitting tool and the splitting chute, allowed to be increased within a pre-determined range, which corresponds to the difference between the maximum and the minimum distance between the splitting tool in the third level and the splitting chute in the fourth level.

The present disclosure further proposes that said difference between the maximum and the minimum distance between the third level of the primary cutting blade of the splitting tool of the splitting unit and the fourth level of the splitting chute is at least 30% of the minimum distance between the third level of the primary cutting blade of the splitting tool and the fourth level of the splitting chute.

In a preferred embodiment of the present disclosure, the splitting chute is, during its movements in direction towards the ground or in opposite direction, guided by means of guiding members and simultaneously elastically supported, so that in a direction towards the ground it is displaceable against the force of springs. Thus, it is further preferred, that said splitting chute is supported by at least four mutually equal compression springs, in particular helical compression springs, which are each guided in a direction towards the ground and protected against buckling, wherein each of said springs has a progressive characteristics, so that by compression of the spring the force generated therein is increasing.

Said minimum distance between the third level of the primary cutting blade of the splitting tool and the fourth level of the splitting chute is adjustable in advance on the basis of adjusting of a position of the primary cutting blade in the third level depending on each desired distance thereof apart from the ground, or on the basis of adjusting of a position of the splitting chute in the fourth level depending on each desired distance thereof from the ground.

In one of the possible embodiments of the machine according to the present disclosure, said primary cutting blade of the splitting tool is in profile shaped as a widely open letter V with its vertex oriented towards the ground, and correspondingly also the splitting chute is in its transversal profile shaped as a widely open letter V with its vertex oriented towards the ground. Thus, said splitting tool is symmetrical with regard to a central plane extending through the vertex of the primary cutting blade. The splitting tool also includes at least two secondary cutting blades, which are arranged symmetrically with respect to said vertex and at least approximately perpendicularly with regard to said primary cutting blade in a direction towards the splitting chute and the ground.

### BRIEF DESCRIPTION OF THE DRAWINGS

The present disclosure will be further explained on the basis of an embodiment, which is presented in the attached drawing, wherein

FIG. 1 is a schematically presented firewood splitting machine in front view.

FIG. 2 is a working area of the machine according to FIG. 1 in isometric view from the top side and prior to splitting of a timber section.

FIG. 3 is a working area of the machine according to FIG. 1 in isometric view from the bottom side and after splitting of a timber section.

FIG. 4 presents an assembly of the splitting tool and the splitting chute in unloaded state of said chute in isometric view.

FIG. 5 presents said assembly according to FIG. 4 in side view.

FIG. 6 presents said assembly of the splitting tool and the splitting chute in loaded state of said chute in isometric view.

FIG. 7 presents said assembly according to FIG. 6 in side view.

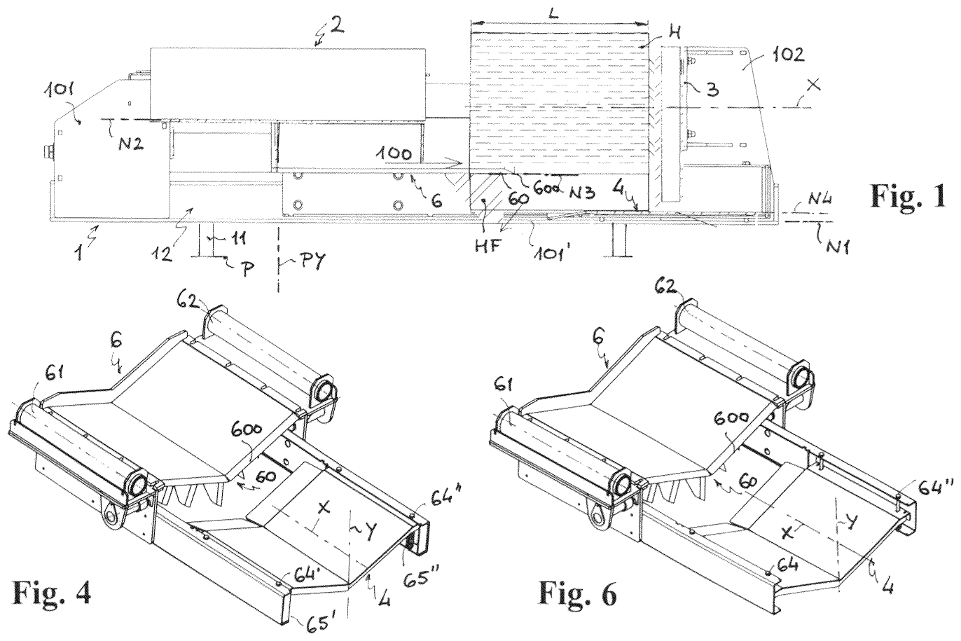

### DETAILED DESCRIPTION

A firewood splitting machine comprises a bearing frame 1 with a hydraulic driving assembly 12, a terminal limiting member 3, a splitting unit 6 and a splitting chute 4, and is, due to its driving and also transporting, adjusted for cooperation with a tractor.

To this aim, a self-standing bearing frame 1 is adapted for resting on a ground P and is supported by supporting legs 11 and is, therefore, maintained at a sufficient distance above the ground P. The bearing frame 1 is detachably connectable to a three-point coupling mechanism of a tractor. Said hydraulic driving assembly 12 is mounted to said bearing frame 1. The hydraulic driving assembly 12 includes a hydraulic pump (not shown in the drawings), which is, via a Cardan shaft, connectable with a driving shaft (not shown in the drawings) on said tractor, as well as a hydraulic liquid reservoir and suitable hydraulic driving means 121, 122 that are, via suitable hydraulic pipes and hydraulic control valves, connected with said hydraulic pump and said hydraulic reservoir.

A hydraulically driven conveying unit 2 is arranged in the one terminal area 101 of said bearing frame 1 of the machine and is suitable for displacing of a timber, which should be thinner than a pre-determined maximum diameter D, along the longitudinal geometric axis X of said bearing frame 1 due to forwarding of each previously cut-off longitudinal timber section H along said longitudinal geometric axis X towards the working area 100, which is located at the first level N1 at a sufficient distance above the ground P and simultaneously lower than the second level N2, in which said conveying unit 2 for supplying of timbers is located. Thus, said first level N1 is located at least at such distance above the ground that deposition of firewood pieces HF onto the ground is feasible.

Moreover, said machine also comprises a cutting unit, which is suitable for successively cutting of each particular timber in order to produce separate longitudinal sections H of pre-determined length L. The cutting unit is located above said conveying unit 2. Moreover, said cutting unit is adjusted for cutting of timbers along the vertical plane PY, which extends rectangular both with respect to the ground P and also to said longitudinal geometric axis X of the bearing frame 1, along which the timber section H is forwarded through the machine.

Said terminal limiting member 3 is arranged in the opposite terminal area 102 of the bearing frame 1, namely opposite to said conveying unit 2. The terminal limiting member 3 is adjusted for supporting said timber section H of a pre-determined length L in a direction along said longitudinal geometric axis X of the bearing frame 1, namely in a direction of successively forwarding of said timber sections H along the machine.

Said splitting unit 6 is driven by at least one hydraulic means 101, 102, which is integrated into said hydraulic driving assembly 12. The splitting unit 6 is guided in said longitudinal direction X of the bearing frame 1 by suitable guiding members 61, 62. Said splitting unit 6 is adapted for splitting of said timber section H to firewood pieces HF. To this end, said splitting unit 6 comprises at least a splitting tool 60, which is displaceable by the driving means 101, 102 back and forth along said longitudinal geometric axis X of the bearing frame 1, and which is furnished with a primary cutting blade 600 located in the third level N3. Said third level N3 is, depending on each selected thickness of firewood pieces HF, located at a pre-determined distance in a direction from the ground P apart from the bottom surface 100′ of the working area 100 in the first level.

The machine further comprises a splitting chute 4, which is adjusted for supporting of said longitudinal timber section H together with splitting-off firewood pieces HF. The firewood pieces HF are gradually separated from timber section H in the area of operation of said splitting tool 60, and is, simultaneously with said splitting tool 60, displaceable back and forth along said longitudinal direction X of the bearing frame 1 and in the same direction as said splitting tool 60. Said splitting chute 4 is located in the fourth level N4, which is located at such distance from the ground P that corresponds to the distance of said primary cutting blade 600 of the cutting tool 6 of the cutting unit 6 in the third level N3 from the ground P, reduced by each estimated thickness of firewood pieces HF.

When observed in a direction of the operational stroke of the splitting tool 60 and the chute 4 during the splitting, namely by moving from the conveying unit 2 towards the terminal limiting member 3, said splitting chute 4 is located in front of the splitting tool 60. Moreover, said splitting chute 4 is, simultaneously with the splitting tool 60 and also in the same direction as the splitting tool 60, displaceable in horizontal direction X, and is displaceable also in vertical direction Y, namely in a direction towards the ground P as well as in opposite direction, so that during displacement of the splitting tool 60 and the splitting chute 4, the distance Δ between the splitting chute 4 and the primary cutting blade 600 of the splitting tool 60 is all the time or constantly changeable within a pre-determined range.

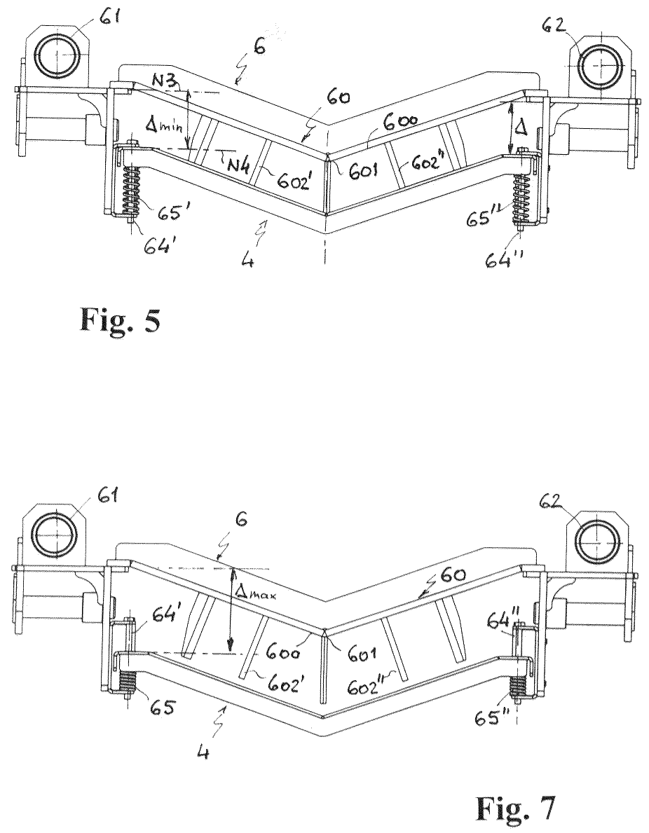

Thus, the minimum distance Δₘᵢₙ (FIG. 5) between the third level N3 of the primary cutting blade 600 of the splitting tool 60 and the fourth level N4 of the splitting chute 4 is changeable and is, prior to splitting, adjustable in advance depending on each desired thickness of firewood pieces HF. The minimum distance Δₘᵢₙ between the third level N3 of the primary cutting blade 600 of the splitting tool 60 and the fourth level N4 of the splitting chute 4 is, during each movement of the splitting tool 60 and the splitting chute 4, allowed to be increased within a pre-determined range, which corresponds to the difference between the maximum distance Δₘₐₓ and the minimum Δₘᵢₙ distance Δ between the splitting tool 60 in the third level N3 and the splitting chute 4 in the fourth level N4.

In order to assure regular operation of the machine within the context of the previously discussed problem, it is usually sufficient, if the difference between the maximum Δₘₐₓ and the minimum Δₘᵢₙ distance Δ between the third level N3 of the primary cutting blade 600 of the splitting tool 60 of the splitting unit 6 and the fourth level N4 of the splitting chute 4 is at least 30% of the minimum distance Δₘᵢₙ between the third level N3 of the primary cutting blade 600 of the splitting tool 60 and the fourth level N4 of the splitting chute 4.

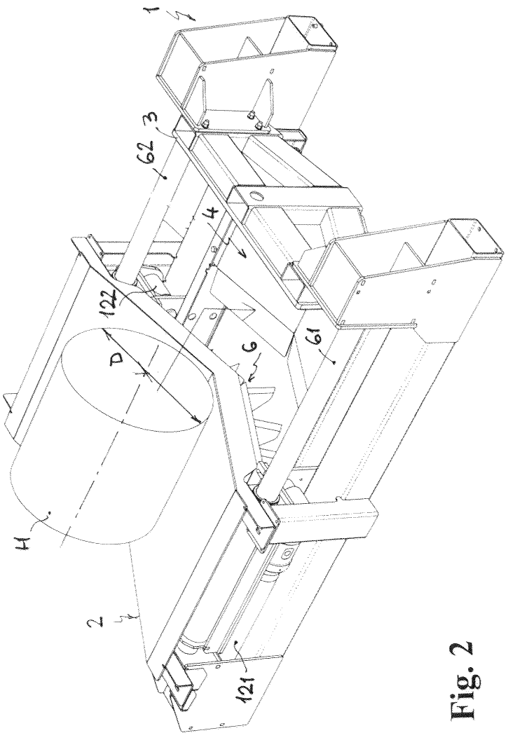

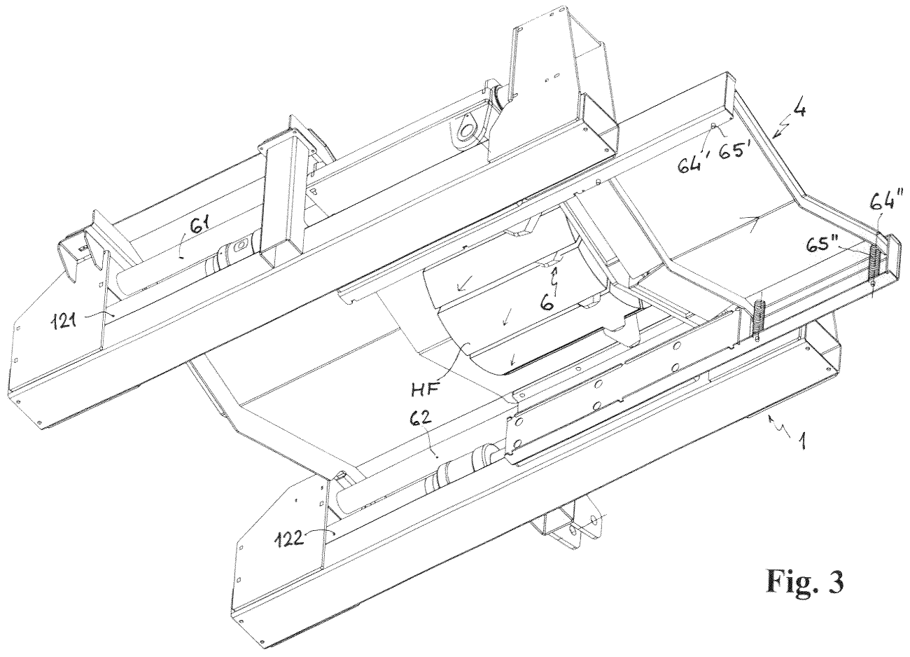

In a preferred embodiment of the present disclosure, which is presented in FIGS. 2-7, said splitting chute 4 is, during its movements in direction towards the ground P, or in opposite direction, guided by means of guiding members 64′, 64″, and is simultaneously elastically supported, so that in a direction towards the ground P it is displaceable against the force of springs 65′, 65″. Regarding the shown embodiment, said splitting chute 4 is supported by four equal helical compression springs 65′, 65″, which are each guided in a direction towards the ground P and are also protected against buckling. Each of said springs 65′, 65″ has a progressive characteristics, so that by compression of the spring 65′, 65″ the force generated therein is increasing. However, those skilled in the art would understand, that still within the context of resolving the initially explained technical problem, there are also several other possibilities of elastically supporting said splitting chute 4, by which the present disclosure could also be properly realized.

Each estimated thickness of firewood pieces is generally determined by minimum distance (FIG. 5) between the third level N3 of the primary cutting blade 600 of the splitting tool 60 and the fourth level N4 of the splitting chute 4. Moreover, a person of ordinary skill in the art would recognize that various splitting tools 60 may be used in the same machine. For that reason, in practice it may be useful, if said minimum distance Δₘᵢₙ is pre-determined and adjusted with regard to each particular circumstances, by adjusting a position of the primary cutting blade 600 of the splitting tool to a pre-determined distance apart from the ground P in the third level N3, and/or adjusting a position of the splitting chute 4 from the ground P in the fourth level N4.

In the shown embodiment, said primary cutting blade 600 of the splitting tool 60 is in profile shaped as a widely open letter V, the vertex 601 of which is directed towards the ground P, and correspondingly, the splitting chute 4 is in its transversal profile shaped as a widely open letter V, the vertex of which is also oriented towards the ground P. In addition to that, in the shown embodiment said splitting tool 60 is conceived symmetrically with regard to a central plane extending through the vertex 601 of the primary cutting blade 600. The splitting tool 60 also comprises at least two secondary cutting blades 602′, 602″, which are arranged symmetrically with respect to said vertex 601 and at least approximately perpendicularly with regard to said primary cutting blade 600 in a direction towards the splitting chute 4 and the ground P.

As soon as the machine is coupled to a tractor, and its belonging hydraulic assembly 12 is activated, a timber with a diameter less than the maximum allowable diameter D can be loaded onto a conveying unit 2. The timber is gradually transported towards the cutting unit, where a longitudinal section H of a pre-determined length L is cut-off and separated from said timber. After that, said longitudinal timber section H is moved to the operational area 100. A splitting tool 60 or a splitting chute 4 located in front of it are present in the operational area 100 above the bottom surface 101′ thereof. Upon displacing of the splitting tool 60 towards the first terminal area 101 of the bearing frame 1 into its initial position, said longitudinal timber section H is placed on the splitting chute 4. Upon activation of the hydraulic driving means 121, 122, the splitting tool 60 starts moving with a suitable speed in a longitudinal direction X along the guiding members 61, 62 in a direction towards the opposite terminal area 102 of the bearing frame 1 and the terminal limiting member 3. As soon as the splitting tool 60 abuts the longitudinal timber section H, the last is pushed towards the terminal limiting member 3, on which it is then rest. After that, the primary cutting blade 600 of the splitting tool 60, together with the available secondary cutting blades 602′, 602″, starts cutting said timber section H, which is herewith gradually split, while at the same time the longitudinal timber section H is permanently supported by the splitting chute 4, which is displaced simultaneously and in the same direction as the splitting tool 60.

Upon splitting, such produced firewood pieces HF can in the area behind the splitting chute 4 freely fall down towards the ground P through the aperture in the bottom surface 101′ of the operational area 100. In the end position of the splitting tool 60, the rest of the longitudinal timber section H remains rest on the surface of the splitting tool 60, so that by returning of the splitting tool 60 back to its initial position, said rest of the timber section H gradually slides into the splitting chute 4, upon which the whole cycle can be repeated.

By suitable selected speed of progression of the splitting tool 60, the timber section H is during the operational stroke of the splitting tool 60 may be gradually split in those areas and along those layers or planes in which the natural structure of the wood requires minimal energy assets. In some cases, for certain types of wood, splitting the ideal splitting plane would at least approximately correspond to a pre-determined distance Δ between the splitting tool 60 and the splitting chute 4. In most cases, the thickness of firewood pieces HF during its splitting apart from the rest of the timber section H may vary, depending on the natural structure of the wood. Previous machines, in the machine according to the present disclosure said distance between the splitting tool 60 and the splitting chute 4 is adjustable to each particular requirements, which are occurring by splitting of firewood pieces HF depending on each particular wood structure, without jamming or cutting the wood in direction transversally or inclined at each disposable wood structure.

What is claimed is:

1. A firewood splitting machine, comprising
a self-standing bearing frame adapted for resting on a ground,
wherein the bearing frame is supported by supporting legs such that the bearing frame is maintained at a first distance above the ground,
wherein the bearing frame is detachably connectable to a three-point coupling mechanism of a tractor,
wherein a hydraulic driving assembly is mounted to said bearing frame, the hydraulic driving assembly comprising:
a hydraulic pump connectable to a driving shaft on said tractor via a Cardan shaft;
a hydraulic liquid reservoir; and
a hydraulic driving means,
wherein the hydraulic driving means is connected to the hydraulic pump and the hydraulic liquid reservoir via hydraulic pipes and hydraulic control valves;
a hydraulically driven conveying unit disposed in a terminal area of said bearing frame,
wherein the conveying unit is configured to displace a timber,
wherein a diameter of the timber is smaller than a pre-determined maximum diameter along a longitudinal geometric axis of said bearing frame,
wherein the pre-determined maximum diameter is based on forwarding cut-off longitudinal timber sections along said longitudinal geometric axis towards a working area of the bearing frame,
wherein the working area is located at a first level that is a first distance above the ground and that is lower than a second level where said conveying unit for supplying of timbers is located;
a cutting unit configured for successively cutting timber into separate longitudinal sections of pre-determined length,
wherein the cutting unit is located above said conveying unit,
wherein said cutting unit is adjusted for cutting of timbers along a vertical plane extending rectangularly with respect to the ground and said longitudinal geometric axis of the bearing frame along which the timber section is forwarded
terminal limiting member disposed in a terminal area of the bearing frame opposite said conveying unit,
wherein the terminal limiting member is adjusted for supporting said timber section of a pre-determined length in a direction along said longitudinal geometric axis of the bearing frame;
a splitting unit guided in said longitudinal direction of the bearing frame by guiding members,
wherein the splitting unit is driven by the hydraulic driving means of the hydraulic driving assembly,
wherein the splitting unit is adapted for splitting of said timber section into firewood pieces,
wherein said splitting unit comprises at least a splitting tool that is displaceable by said hydraulic driving means back and forth along said longitudinal geometric axis of the bearing frame, and
wherein the splitting tool comprises a primary cutting blade located at a third level, wherein the third level is located at a pre-determined distance from the ground (P) and from the first level of a bottom surface of the working area, wherein the pre-determined distance is based on a selected thickness of each of the firewood pieces; and
a splitting chute adjusted for supporting said timber and for gradually splitting-off firewood pieces at least in the area of operation of said splitting tool, wherein the splitting chute is simultaneously displaceable with said splitting tool back and forth along said longitudinal direction of the bearing frame,
wherein said splitting chute is located in a fourth level,
wherein the fourth level is a distance from the ground that is substantially smaller than a distance of the primary cutting blade of the splitting tool of the splitting unit in the third level from the ground,
wherein said splitting chute, when observed in a direction of an operational stroke of the splitting tool and the splitting chute during the splitting by moving from the conveying unit towards the terminal limiting member, is located in front of the splitting tool, and
wherein said splitting chute is, simultaneously with the splitting tool (60) and in a same direction as the splitting tool (60), displaceable in horizontal direction and in vertical direction in a direction towards the ground and in opposite direction, so that, during displacement of the splitting tool and the splitting chute, the distance between the splitting chute and the primary cutting blade of the splitting tool is all the time _changeable within a pre-determined range,
wherein a minimum distance between the third level of the primary cutting blade of the splitting tool and the fourth level of the splitting chute is changeable and adjustable prior to the splitting depending on each selected thickness of firewood pieces,
wherein said minimum distance is allowed to be increased within a pre-determined range during each movement of the splitting tool and the splitting chute based on the difference between the maximum distance and the minimum distance between the splitting tool in the third level and the splitting chute in the fourth level.

2. The firewood splitting machine of claim 1, wherein said difference between the maximum distance and the minimum distance between the third level of the primary cutting blade of the splitting tool of the splitting unit and the fourth level of the splitting chute is at least 30% of the minimum distance between the third level of the primary cutting blade of the splitting tool and the fourth level of the splitting chute.

3. The firewood splitting machine of claim 1, wherein said splitting chute is guided by guiding members and simultaneously elastically supported, so that the splitting chute is displaceable in a direction towards the ground against the force of springs.

4. to the firewood splitting machine of claim 3, wherein said splitting chute is supported by at least four mutually equal compression springs,
wherein each compression spring is guided in a direction towards the ground and protected against buckling.

5. The firewood splitting machine of claim 1, wherein said springs are helical compression springs.

6. The firewood splitting machine of claim 3, wherein each of said springs has progressive characteristics, so that a force generated by compression of each spring is increasing.

7. The firewood splitting machine of claim 1, wherein each minimum distance between the third level of the primary cutting blade of the splitting tool and the fourth level of the splitting chute is adjustable in advance on the basis of adjusting of a position of the primary cutting blade in the third level depending on each desired distance thereof from the ground.

8. The firewood splitting machine of claim 1, wherein each minimum distance between the third level of the primary cutting blade of the splitting tool and the fourth level of the splitting chute is adjustable in advance based on adjusting of a position of the splitting chute in the fourth level depending on each desired distance thereof from the ground.

9. The firewood splitting machine of claim 1, wherein said primary cutting blade of the splitting tool is, in profile, shaped as a widely open letter V having a vertex oriented towards the ground, and
wherein the splitting chute is, in a transversal profile, shaped as a widely open letter V having a vertex oriented towards the ground.

10. The firewood splitting machine of claim 9, wherein said splitting tool is symmetrical with regard to a central plane extending through the vertex of the primary cutting blade, and
wherein the splitting tool comprises at least two secondary cutting blades that are arranged symmetrically with respect to said vertex of the primary cutting blade and at least approximately perpendicularly with regard to said primary cutting blade in a direction towards the splitting chute and the ground.
